(19) United States
(12) Patent Application Publication
(10) Pub. No.: US 2016/0241611 A1
(43) Pub. Date: Aug. 18, 2016

(54) TOPIC-WISE COLLABORATION INTEGRATION

(71) Applicant: LONGSAND LIMITED, Cambridge (GB)

(72) Inventor: Narayana Rao SVN, Bangalore (IN)

(73) Assignee: LONGSAND LIMITED, Cambridge (GB)

(21) Appl. No.: 15/025,660

(22) PCT Filed: Oct. 31, 2013
(86) PCT No.: PCT/IN2013/000676

§ 371 Date: Mar. 29, 2016

(51) Int. Cl. H04L 29/06; G06F 17/30; G06F 17/24; G06F 3/0484

(52) U.S. Cl. CPC H04L 65/403; G06F 3/04842; G06F 17/30011; G06F 17/248; G06F 17/30598; G06F 17/30896; G06F 17/30887

(57) ABSTRACT

According to an example, topic-wise collaboration integration may include receiving a user selection of a topic from a document from a source content management system. An indication to trigger a structured collaboration on the topic may be received. A web template may be generated to perform the structured collaboration on the topic. Contents related to discussions on the topic may be received from users. A summary of the received contents may be generated. The summary may be provided to a content producer of the document. An indication from the content producer related to a validity of the summary and an integration of the summary into the document may be received. Instructions may be sent to the source content management system to append the summary to the document and/or integrate the summary into the document.

### BACKGROUND

Collaboration provides for individuals working together in a coordinated fashion to achieve a common goal. Collaboration applications are typically used to help such individuals involved in common tasks achieve goals. Collaboration applications typically facilitate individuals working together over dispersed geographic areas by providing tools that aid communication, collaboration, and problem solving. Collaboration applications also support project management functions, such as task assignments, time-management deadlines, and shared calendars.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a topic-wise collaboration integration apparatus, according to an example of the present disclosure;

FIG. 2 illustrates an application example of the topic-wise collaboration integration apparatus of FIG. 1, for a user interested in a topic “Host Controller and NSASJ Sever Components,” according to an example of the present disclosure;

FIG. 3 illustrates a configuration management directory for the application example of FIG. 2, illustrating storage of a document (e.g., an Extensible Markup Language (XML) file), according to an example of the present disclosure;

FIG. 4 illustrates contents of the document of FIG. 3, including the topic “Host Controller and NSASJ Sever Components,” according to an example of the present disclosure;

FIG. 5 illustrates a web template initiated by a user for the application example of FIG. 2 for the topic “Host Controller and NSASJ Sever Components,” according to an example of the present disclosure;

FIG. 6 illustrates the web template of FIG. 5 with collaboration details from other users for the application example of FIG. 2, according to an example of the present disclosure;

FIG. 7 illustrates the web template of FIG. 5 with summary and raw discussion details for the application example of FIG. 2, according to an example of the present disclosure;

FIG. 8 illustrates the original document with summary appended for the application example of FIG. 2, according to an example of the present disclosure;

FIG. 9 illustrates a method for topic-wise collaboration integration, according to an example of the present disclosure;

FIG. 10 illustrates further details of the method for topic-wise collaboration integration, according to an example of the present disclosure; and

FIG. 11 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

With the increased complexity of enterprise products and components, it can be challenging for users such as customers, support engineers, and/or field representatives to refer to the needed source of information, and understand the details needed to solve a problem at hand. For example, with respect to attaching a product such as a storage blade to a server, or for performing other configuration and/or trouble-shooting related to a product, a user may need to refer to technical product documentation. Such technical product documentation can often be complex, and may need extensive research before a user is able to fully comprehend how to address the problem at hand. In an effort to save time, the user may also prefer posting questions on known forums and/or social media websites, and attempt to understand the responses provided by other users. Users may resort to posting of questions on known forums and/or social media websites, for example, because the users typically have limited to no opportunity to interact with authors of technical product documentation in the area of interest. Further, users typically have limited to no opportunity to interact with other subject matter experts, and may therefore resort to attempting to understand responses from other users on various forums.

According to an example, a topic-wise collaboration integration apparatus and a method for topic-wise collaboration integration are disclosed herein. The apparatus and method disclosed herein may generally provide for a content consumer (e.g., a user) to trigger a structured collaboration on a given topic, for example, for a document from a source content management system, among other users. The apparatus and method disclosed herein may generate a summary of the discussions on the topic, and also on similar topics (if available). As described in further detail below, the summary may be derived, for example, by using machine learning techniques related to clustering. The summary may be stored in the source content management system. Further, the apparatus and method disclosed herein may provide for a content producer (e.g., an author of the document from the source content management system, and/or subject matter expert on a given topic) to validate the summary, and to integrate the summary back into the document from the source content management system from where the topic originated. For example, the content owner may make an appropriate decision to either append the summary to the document from the source content management system, or to modify the document as needed.

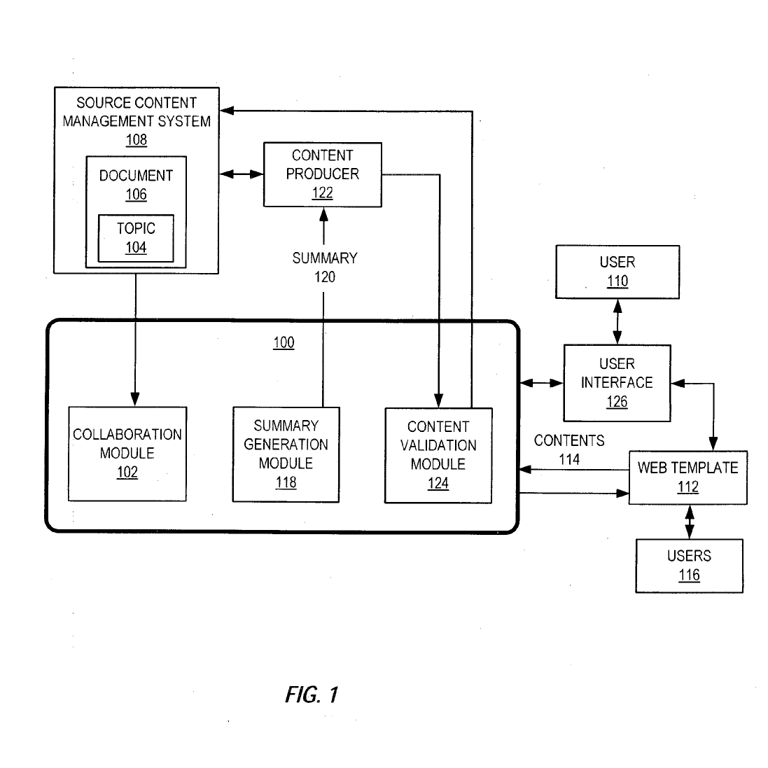

FIG. 1 illustrates an architecture of a topic-wise collaboration integration apparatus 100, according to an example of the present disclosure. Referring to FIG. 1, the topic-wise collaboration integration apparatus 100 is depicted as including a collaboration module 102 to receive selection of a topic 104 from a document 106 from a source content management system 108 by a user 110. The collaboration module 102 may further receive an indication to trigger a structured collaboration on the topic 104 from the user 110. In response to receiving the indication to trigger the structured collaboration on the topic 104, the collaboration module 102 may generate a web template 112 to perform the structured collaboration on the topic 104. The collaboration module 102 may receive contents 114 related to discussions on the topic 104 from a plurality of users 116, including the user 110. A summary generation module 118 may generate a summary 120 of the received contents 114 (and also on contents related to similar topics). The summary generation module 118 may provide the summary 120 to a content producer 122 of the document 106. A content validation module 124 may receive an indication from the content producer 122 related to a validity of the summary 120, and further related to an integration of the summary 120 into the document 106. In response to receiving the indication from the content producer 122, the content validation module 124 may send instructions to the source content management system 108 to append the summary 120 to the document 106 and/or integrate the summary 120 into the document 106. A user interface (UI) 126 may display, for example, various options, the document 106, the contents 114, and the summary 120, associated with the topic-wise collaboration integration apparatus 100.

As described herein, the modules and other elements of the apparatus 100 may be machine readable instructions stored on a non-transitory computer readable medium. In addition, or alternatively, the modules and other elements of the apparatus 100 may be hardware or a combination of machine readable instructions and hardware.

Referring to FIG. 1, the collaboration module 102, the summary generation module 118, and the content validation module 124, according to examples thereof, are described in further detail.

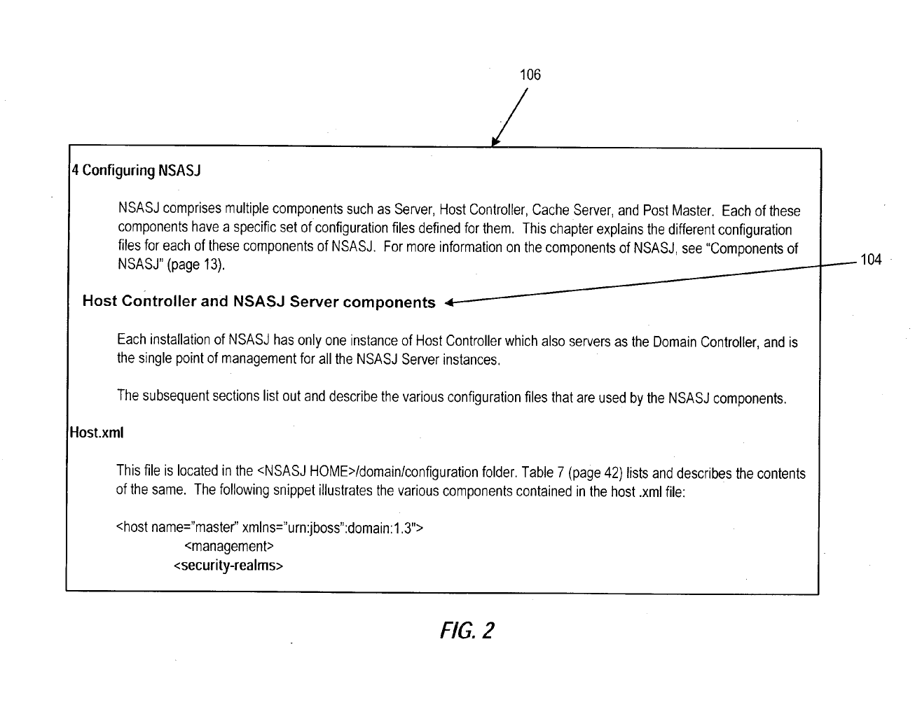

The collaboration module 102 may provide the user 110 access to the document 106 via the UI 126. The collaboration module 102 may include any type of document reader for providing access to the document 106. The collaboration module 102 may also include, for example, a mobile reader for obtaining access through a mobile device used by the user 110. The collaboration module 102 may receive selection of the topic 104 from the document 106 from the source content management system 108 by the user 110. For example, FIG. 2 illustrates an application example of the topic-wise collaboration integration apparatus 100, for the user 110 interested in the topic 104 (e.g., “Host Controller and NSASJ Sever Components”) according to an example of the present disclosure. The user 110 may select the topic 104, for example, by highlighting the topic 104.

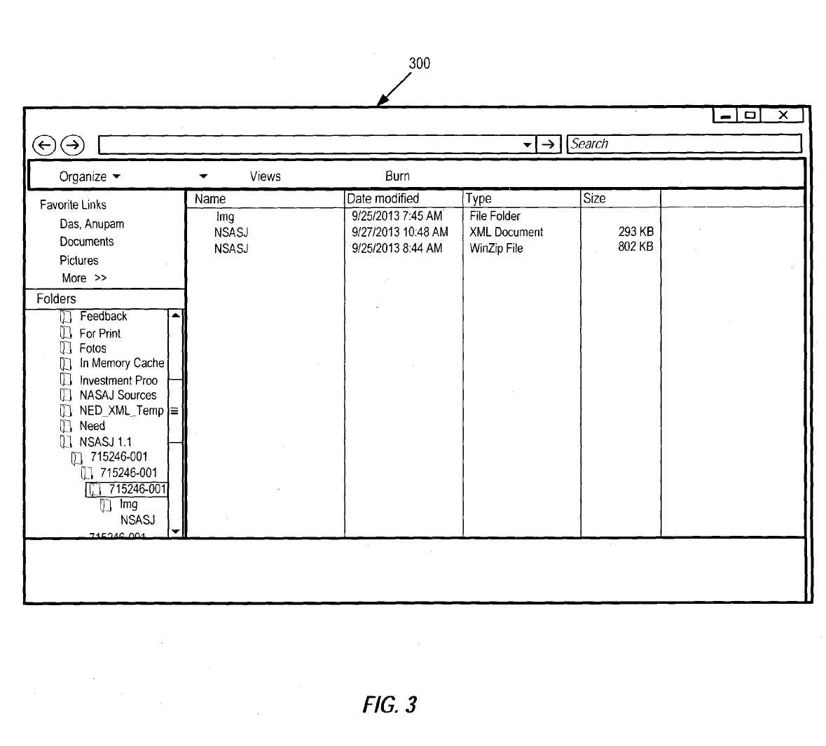

FIG. 3 illustrates a configuration management directory 300 for the source content management system 108 for the application example of FIG. 2, illustrating storage of the document source file (e.g., an XML file, which is used to generate a HTML file or pdf file) in the source content management system 108, according to an example of the present disclosure. The document 106 may be provided in any format, such as, for example, HTML, pdf, etc., that the user 110 may view and use to select the topic 104.

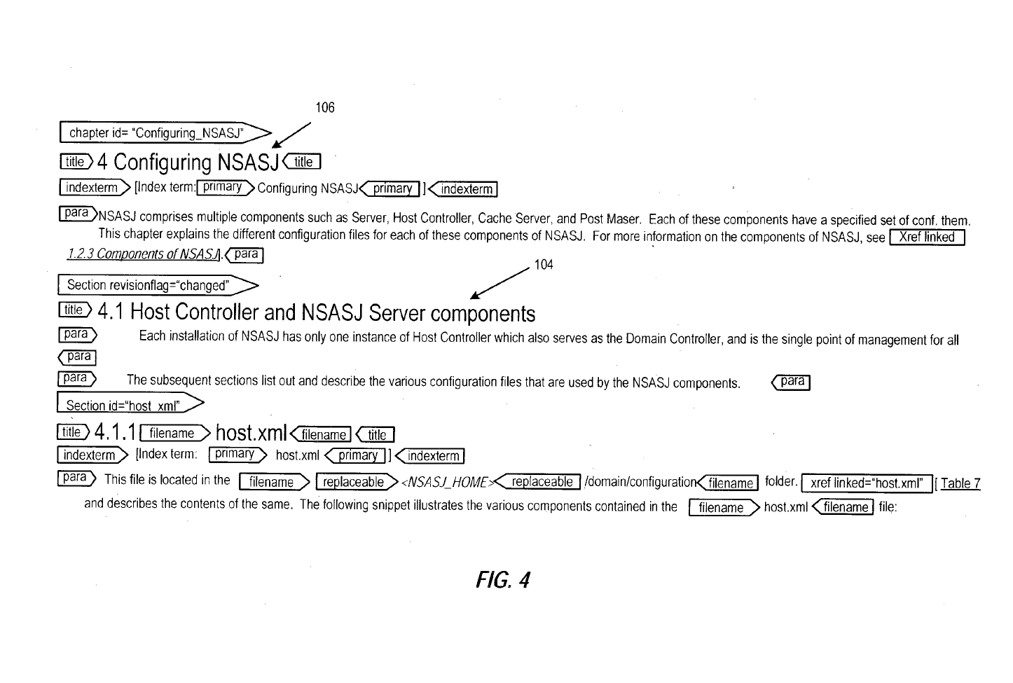

FIG. 4 illustrates contents of the document 106 of FIG. 3, according to an example of the present disclosure. The user 110 may access the document 106 from the source content management system 108, which may include a content manager, publishing house, or any other delivery mechanism into which the source content management system 108 is integrated.

The collaboration module 102 may receive an indication to trigger a structured collaboration on the topic 104 from the user 110. For example, the user 110 may highlight the topic 104, and may further select a collaboration option on the UI display 126 to trigger a structured collaboration on the topic 104.

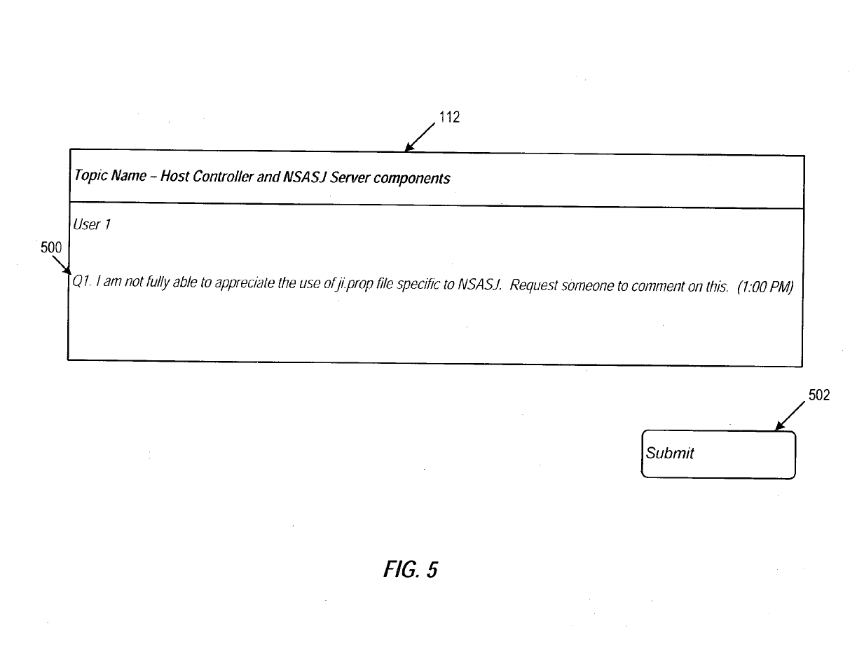

In response to receiving the indication to trigger the structured collaboration on the topic 104, the collaboration module 102 may generate the web template 112 to perform the structured collaboration on the topic 104. For example, FIG. 5 illustrates the web template 112 initiated by the user 110 for the application example of FIG. 2, according to an example of the present disclosure. The web template 112 may include the topic 104 as a heading. The use of the heading that is the same as or similar to the topic 104 may facilitate storage of the web template 112 in the source content management system 108. The use of the heading that is the same as or similar to the topic 104 may also facilitate further analysis related to the contents 114 and the summary 120.

For the example of FIG. 5, the web template 112 may include a uniform resource locator (URL) http://www.XYZ.html that may be used to launch the web template 112. The web template 112 may include further information and/or instructions to the user 110 and/or to the users 116 for entering the contents 114 into the web template 112. As shown in the example of FIG. 5, the user 110 may add a specific question 500 related to the topic 104. The user 110 may launch the web template 112 on a forum by selecting the submit option 502, and by further posting the URL of the completed web template 112 on the forum. The forum may include, for example, a social media network such as TWITTER, or other such applications to launch the web template 112.

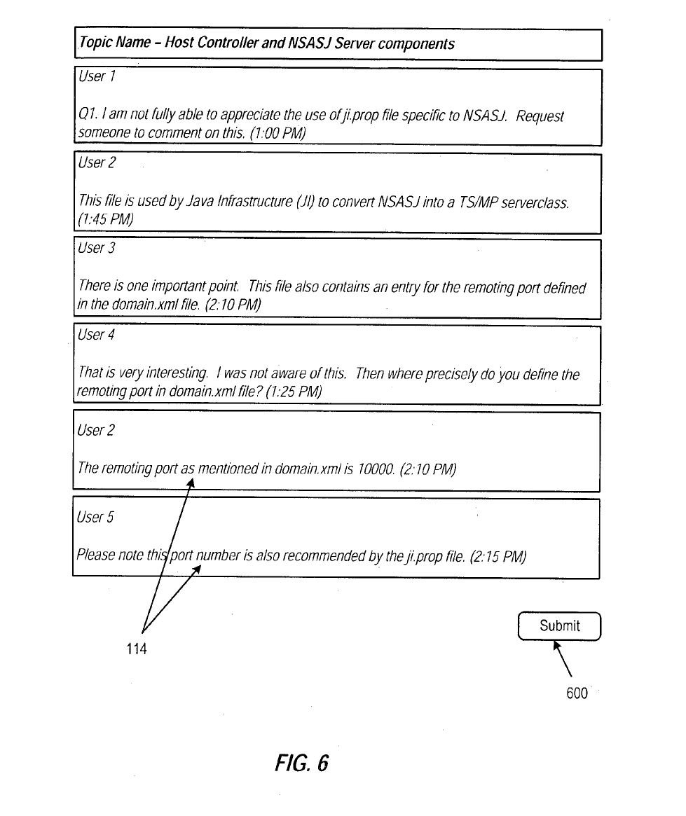

The collaboration module 102 may receive the contents 114 related to discussions on the topic 104 from a plurality of the users 116 including the user 110. The users 116 may access the web template 112, for example, by entering the URL in a browser. For example, FIG. 6 illustrates the web template 112 of FIG. 5 with the contents 114 (e.g., collaboration details) from other users 116 for the application example of FIG. 2, according to an example of the present disclosure. The contents 114 may be received from the users 116 that have responded to the posting of the URL (e.g., http://www.XYZ.html for the example of FIG. 5) related to the web template 112 on a forum. The user 110 may conclude the discussions related to the topic 104 by selecting a submit option 600. Selection of the submit option 600 may trigger the summary generation module 118 to generate the summary 120 of the received contents 114. Further, based on the selection of the submit option 600, the web template 112 may be stored in the source content management system 108, for example, at the same or similar location relative to the original document 106.

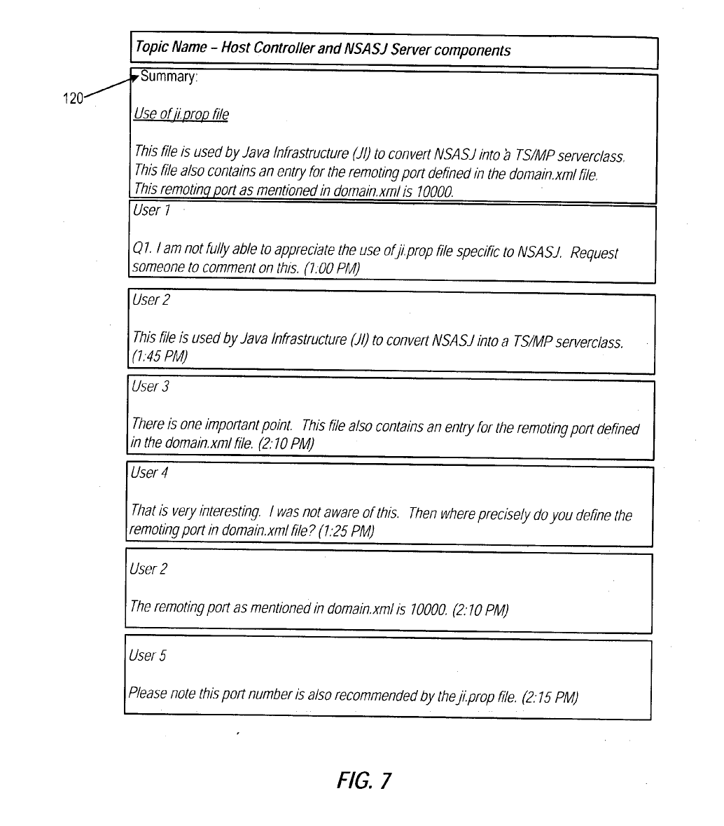

As disclosed herein, the summary generation module 118 may generate the summary 120 of the received contents 114. For example, FIG. 7 illustrates the web template 112 of FIG. 5 with the summary 120 and raw discussion details (e.g., the contents 114) for the application example of FIG. 2, according to an example of the present disclosure. The summary 120 may be generated based on clustering of the received contents 114. For example, the summary 120 may be generated using K-means clustering to group sentences from the received contents 114 into theme clusters. With respect to theme clusters, given a document set (i.e., one or more of the web pages similar to web template of FIG. 6), the number k of expected clusters may be determined as follows:

k=\sqrt{|V|} Equation (1)

For Equation (1), |V| may represent the number of all sentences in the document set. With respect to K-means clustering, k sentences may be selected as the initial centroids of the k clusters. The K-means clustering process may then iteratively assign all sentences to the closest cluster, and re-compute the centroid of each cluster, until the centroids do not change. The similarity between a sentence and a cluster centroid may be computed using a cosine measure as follows:

$$f ( i \to j ) = {sim}_{cosine} ( {v}_{i} , {v}_{j} ) = \frac{\vec{{v}_{i}} \cdot \vec{{v}_{j}}}{\vert \vec{{v}_{i}} \vert \times \vert \vec{{v}_{j}} \vert} \qquad Equation ( 2 )$$

For Equation (2), f(i→j) may represent the similarity between sentence i and cluster centroid j, vᵢ may represent sentence i, vⱼ may represent sentence j,\vec{vₗ} may represent a vector representation of sentence i, \vec{vⱼ} may represent a vector representation of sentence j, and |\vec{vₗ}|×|\vec{vⱼ}| may represent the dot product of the vectors \vec{vₗ} and \vec{vⱼ}.

Alternatively or additionally, the summary 120 may be generated by computing a saliency score for sentences from the received contents 114 to incorporate the cluster-level information. For example, the summary 120 may be generated by using a cluster based HITS model that uses sentence-to-cluster relationships. For the HITS model, sentences may be referred to as authorities and clusters may be referred to as hubs. Authority scores may be determined for sentences and hub scores may be determined for clusters as follows:

L_{i,j}=wᵢⱼ=sim_{cosine}(vᵢ,cⱼ) Equation (3)

AuthScore^{(t+1)}(vᵢ)=Σ_{c}_{ⱼ}_{∈V}_{_{c}}wᵢⱼ·HubScore^{(t)}(cⱼ) Equation (4)

HubScore^{(t+1})(cⱼ)=Σᵥ_{ᵢ}_{∈V}_{ₛ}wᵢⱼ·AuthScore^{(t)}(vᵢ) Equation (5)

For Equations (3-5), vᵢ may represent sentence i, cⱼ may represent cluster j, wᵢⱼ (Lᵢⱼ) may denote the strength of the relationship between the sentence vᵢ and the cluster cⱼ, Vₛ=V={vᵢ} may represent the set of sentences (i.e., authorities), V_{c}=C={cⱼ} may represent the set of theme clusters (i.e., hubs), AuthScore^{(t+1)}(vⱼ) may represent the authority score of sentence vᵢ at the (t+1)^{th} iteration, and HubScore^{(t+1)}(cⱼ) may represent the hub score of cluster cⱼ at the (t+1)^{th} iteration. For computation of the scores with respect to Equations (3-5), the initial scores of all sentences and clusters may be set to 1, and the iterations may be used to compute the new scores until convergence. Convergence may be achieved when the difference between the scores computed at two successive iterations for any sentences and clusters falls below a given threshold.

Alternatively or additionally, the summary 120 may be generated by extracting the summary from selected summary sentences from the received contents 114. In this regard, authority scores (e.g., from Equation (4)) may be used as the saliency scores for the sentences. Further, the sentences may be ranked and then selected for the summary 120 based on the ranking, and selection of a predetermined number of top ranked sentences (e.g., top 5) for the summary 120.

The summary generation module 118 may further provide the summary 120 generated from the foregoing techniques related to theme cluster detection, sentence score computation, and summary extraction, to the content producer 122 of the document 106. The summary 120, and the web template 112 including the summary 120 and the contents 114, may be stored in the source content management system 108. The summary 120 may include information that the content producer 122 may consider for improving the quality of the document 106.

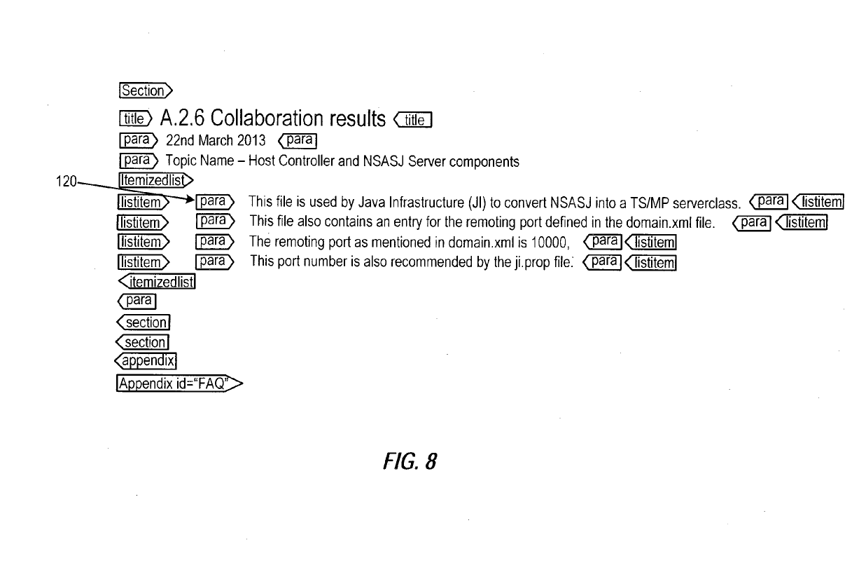

The content validation module 124 may receive an indication from the content producer 122 related to a validity of the summary 120, and further related to an integration of the summary 120 into the document 106. For example, the content producer 122 may review and validate the summary 120, and may further decide to append the summary 120 to a predetermined section of the document 106. Alternatively or additionally, the content producer 122 may create a new section in the document 106, and may denote the new section, for example, as collaboration results in the document 106. Alternatively or additionally, when the user 110 selects the submit option 600, the collaboration module 102 may open the document 106 (or a source file related to the document 106), and may append the summary 120 to a predetermined section of the document 106. For example, the collaboration module 102 may append the summary 120 to a “collaboration results” section of the document 106. Further, in response to receiving the indication of validity from the content producer 122, the content validation module 124 may send instructions to the source content management system 108 to append the summary 120 to the document 106 and/or to integrate the summary 120 into the document 106. For example, FIG. 8 illustrates the original document 106 (e.g., the source XML file) with the summary 120 appended for the application example of FIG. 2, according to an example of the present disclosure.

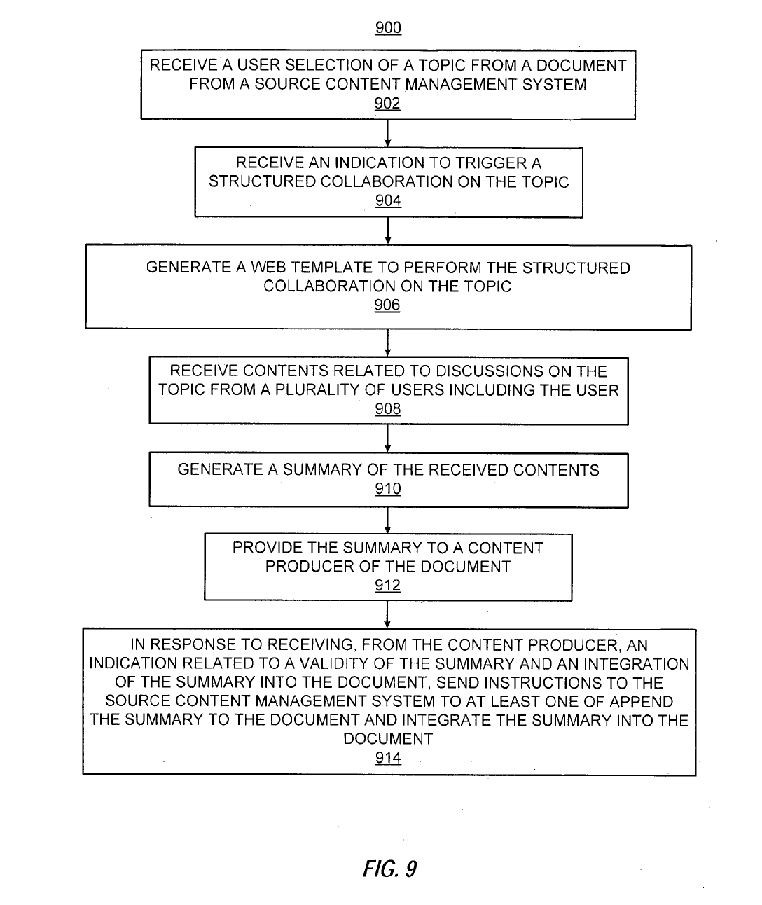

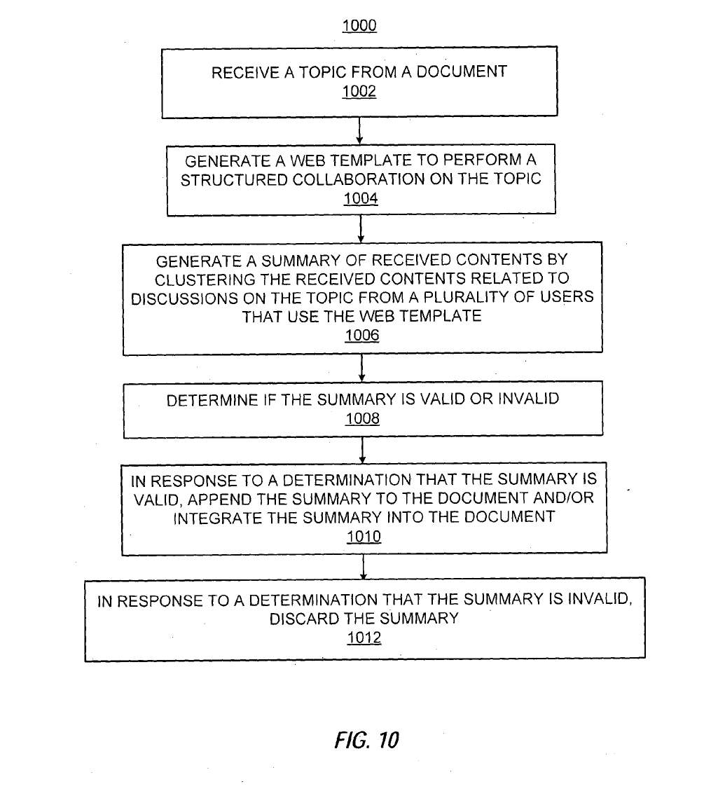

FIGS. 9 and 10 respectively illustrate flowcharts of methods 900 and 1000 for topic-wise collaboration integration, corresponding to the example of the topic-wise collaboration integration apparatus 100 whose construction is described in detail above. The methods 900 and 1000 may be implemented on the topic-wise collaboration integration apparatus 100 with reference to FIGS. 1-8 by way of example and not limitation. The methods 900 and 1000 may be practiced in other apparatus.

Referring to FIG. 9, for the method 900, at block 902, the method may include receiving a user selection of a topic from a document from a source content management system. For example, referring to FIG. 1, the method may include receiving a user selection (e.g., from the user 110) of the topic 104 from the document 106 from the source content management system 108.

At block 904, the method may include receiving an indication to trigger a structured collaboration on the topic. For example, referring to FIGS. 1 and 2, the method may include receiving an indication to trigger a structured collaboration on the topic 104 (e.g., where the user 110 highlights the topic 104).

At block 906, the method may include generating a web template to perform the structured collaboration on the topic. For example, referring to FIGS. 1 and 5, the method may include generating the web template 112 to perform the structured collaboration on the topic 104 by the collaboration module 102.

At block 908, the method may include receiving contents related to discussions on the topic from a plurality of users including the user. For example, referring to FIGS. 1 and 6, the method may include receiving the contents 114 related to discussions on the topic 104 from a plurality of the users 116 including the user 110.

At block 910, the method may include generating a summary of the received contents. For example, referring to FIGS. 1 and 7, the method may include generating the summary 120 of the received contents 114 by the summary generation module 118.

At block 912, the method may include providing the summary to a content producer of the document. For example, referring to FIG. 1, the method may include providing the summary 120 to the content producer 122 of the document 106.

At block 914, in response to receiving, from the content producer, an indication related to a validity of the summary and an integration of the summary into the document, the method may include sending instructions to the source content management system to append the summary to the document and/or to integrate the summary into the document. For example, referring to FIG. 1, the method may include receiving, from the content producer 122, an indication at the content validation module 124, related to a validity of the summary 120, and further related to an integration of the summary 120 into the document 106. Further, the method may include sending instructions to the source content management system 108 to append the summary to the document 106 and/or to integrate the summary 120 into the document 106.

According to an example, for the method 900, receiving a user selection of the topic 104 from the document 106 from the source content management system 108 may further include receiving selection of a highlighted area (e.g., see FIG. 2) of the document 106 that is designated as the topic 104.

According to an example, for the method 900, receiving an indication to trigger a structured collaboration on the topic 104 may further include receiving an indication from the user to trigger the structured collaboration on the highlighted area of the document 106 that is designated as the topic 104.

According to an example, for the method 900, generating the summary 120 of the received contents 114 may further include clustering the received contents 114 to generate the summary 120. According to particular examples, the clustering may be performed, for example, by using K-means clustering to group sentences from the received contents 114 into theme clusters, and/or by computing a saliency score of sentences from the received contents 114 to incorporate the cluster-level information. According to another example, generating the summary 120 of the received contents 114 may further include extracting the summary 120 from selected summary sentences from the received contents 114.

According to an example, for the method 900, receiving the contents 114 related to discussions on the topic 104 from a plurality of users 116 including the user 110 may further include receiving the contents 114 related to discussions on the topic 104 from the plurality of users 116 that have responded to a posting of a URL related to the web template 112 on a forum.

According to an example, for the method 900, receiving the contents 114 related to discussions on the topic 104 from the plurality of users 116 including the user 110 may further include receiving the contents 114 in response to a question (e.g., see FIG. 5) posted by the user 110 on the web template 112.

According to an example, the method 900 may further include generating instructions to store the web template 112 including the summary 120 and the received contents 114 in the source content management system 108 for access by the content producer 122.

According to an example, the method 900 may further include generating instructions to store the web template 112 including the summary 120 and the received contents 114 in the source content management system 108 in the same location as the document 106.

According to an example, for the method 900, generating the web template 112 to perform the structured collaboration on the topic 104 may further include assigning a URL that includes a portion of the topic 104 to the web template 112.

Referring to FIG. 10, for the method 1000, at block 1002, the method may include receiving a topic from a document. For example, referring to FIG. 1, the method may include receiving the topic 104 from the document 106.

At block 1004, the method may include generating a web template to perform a structured collaboration on the topic. For example, referring to FIGS. 1 and 5, the method may include generating the web template 112 to perform the structured collaboration on the topic 104.

At block 1006, the method may include generating a summary of received contents by clustering the received contents related to discussions on the topic from a plurality of users that use the web template. For example, referring to FIGS. 1 and 6, the method may include receiving the contents 114 related to discussions on the topic 104 from a plurality of the users 116 that use the web template 112. Further, referring to FIGS. 1 and 7, the method may include generating the summary 120 of the received contents 114 by clustering the received contents 114.

At block 1008, the method may include determining if the summary is valid or invalid. For example, referring to FIG. 1, the method may include using the content validation module 124 to determine if the summary is valid or invalid.

At block 1010, in response to a determination that the summary is valid, the method may include appending the summary to the document and/or integrating the summary into the document. For example, referring to FIG. 1, in response to a determination that the summary is valid, the method may include appending the summary 120 to the document 106 and/or integrating the summary 120 into the document 106.

At block 1012, in response to a determination that the summary is invalid, the method may include discarding the summary. For example, referring to FIG. 1, in response to a determination that the summary 120 is invalid, the method may include discarding the summary 120.

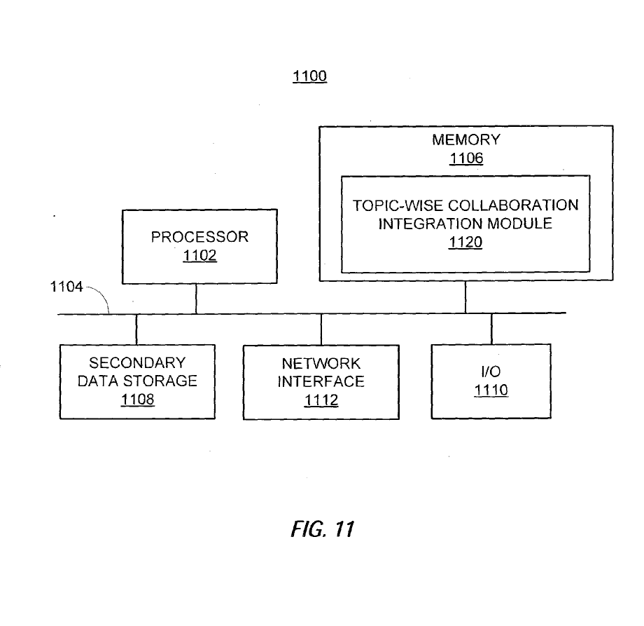

FIG. 11 shows a computer system 1100 that may be used with the examples described herein. The computer system may represent a generic platform that includes components that may be in a server or another computer system. The computer system 1100 may be used as a platform for the apparatus 100. The computer system 1100 may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 1100 may include a processor 1102 that may implement or execute machine readable instructions performing some or all of the methods, functions and other processes described herein. Commands and data from the processor 1102 may be communicated over a communication bus 1104. The computer system may also include a main memory 1106, such as a random access memory (RAM), where the machine readable instructions and data for the processor 1102 may reside during runtime, and a secondary data storage 1108, which may be non-volatile and stores machine readable instructions and data. The memory and data storage are examples of computer readable mediums. The memory 1106 may include a topic-wise collaboration integration module 1120 including machine readable instructions residing in the memory 1106 during runtime and executed by the processor 1102. The topic-wise collaboration integration module 1120 may include the modules of the apparatus 100 shown in FIG. 1.

The computer system 1100 may include an I/O device 1110, such as a keyboard, a mouse, a display, etc. The computer system may include a network interface 1112 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for topic-wise collaboration integration, the method comprising:
receiving a user selection of a topic from a document from a source content management system;
receiving an indication to trigger a structured collaboration on the topic;
generating a web template to perform the structured collaboration on the topic;
receiving contents related to discussions on the topic from a plurality of users including the user;
generating a summary of the received contents;
providing the summary to a content producer of the document; and
in response to receiving, from the content producer, an indication related to a validity of the summary and an integration of the summary into the document, sending, by a processor, instructions to the source content management system to at least one of append the summary to the document and integrate the summary into the document.

2. The method of claim 1, wherein receiving a user selection of a topic from a document from a source content management system further comprises:
receiving the user selection of a highlighted area of the document that is designated as the topic.

3. The method of claim 2, wherein receiving an indication to trigger a structured collaboration on the topic further comprises:
receiving an indication from the user to trigger the structured collaboration on the highlighted area of the document that is designated as the topic.

4. The method of claim 1, wherein generating a summary of the received contents further comprises:
clustering the received contents to generate the summary.

5. The method of claim 4, wherein clustering the received contents to generate the summary further comprises:
using K-means clustering to group sentences from the received contents into theme clusters.

6. The method of claim 4, wherein clustering the received contents to generate the summary further comprises:
computing a saliency score of sentences from the received contents to generate clusters.

7. The method of claim 1, wherein generating a summary of the received contents further comprises:
extracting the summary from selected summary sentences from the received contents.

8. The method of claim 1, wherein receiving contents related to discussions on the topic from a plurality of users including the user further comprises:
receiving contents related to discussions on the topic from the plurality of users that have responded to a posting of a uniform resource locator (URL) related to the web template on a forum.

9. The method of claim 1, wherein receiving contents related to discussions on the topic from a plurality of users including the user further comprises:
receiving the contents in response to a question posted by the user on the web template.

10. The method of claim 1, further comprising:
generating instructions to store the web template including the summary and the received contents in the source content management system for access by the content producer.

11. The method of claim 1, further comprising:
generating instructions to store the web template including the summary and the received contents in the source content management system in the same location as the document.

12. The method of claim 1, wherein generating a web template to perform the structured collaboration on the topic further comprises:
assigning a uniform resource locator (URL) that includes a portion of the topic to the web template.

13. A topic-wise collaboration integration apparatus comprising:
a processor; and
a memory storing machine readable instructions that when executed by the processor cause the processor to:
receive an indication to trigger a structured collaboration on a topic selected from a document by a user;
generate a web template to perform the structured collaboration on the topic, wherein the web template includes a uniform resource locator (URL) related to the web template;
generate a summary of received contents related to discussions on the topic from a plurality of users that have responded to a posting of the URL related to the web template on a forum;
provide the summary to a content producer of the document;
receive an indication from the content producer related to a validity of the summary; and
at least one of append the summary to the document and integrate the summary into the document.

14. The topic-wise collaboration integration apparatus according to claim 13, further comprising machine readable instructions to cause the processor to:
cluster the received contents to generate the summary.

15. A non-transitory computer readable medium having stored thereon machine readable instructions to provide topic-wise collaboration integration, the machine readable instructions, when executed, cause a computer system to:
receive a topic from a document;
generate a web template to perform a structured collaboration on the topic;
generate a summary of received contents by clustering the received contents related to discussions on the topic from a plurality of users that use the web template;
determine if the summary is valid or invalid;
in response to a determination that the summary is valid, at least one of append the summary to the document and integrate the summary into the document; and
in response to a determination that the summary is invalid, discard the summary.
